(19) United States
(12) Patent Application Publication
(10) Pub. No.: US 2007/0226065 A1
(43) Pub. Date: Sep. 27, 2007

(54) System & Method For Augmenting Sales in Small Footprint Retail Establishments

(76) Inventors: Mary Catherine Shepherd, Middletown, OH (US); David Lee Smith, Atlanta, GA (US)

Correspondence Address: GEORGE R. REARDON, 3356 STATION COURT, LAWRENCVILLE, GA, 30044, US

(21) Appl. No.: 11/276,943

(22) Filed: Mar. 17, 2006

(51) Int. Cl. G06Q 30/00

(52) U.S. Cl. 705/26

(57) ABSTRACT

A system and method for increasing sales at stores with limited inventory space is described. The system and method facilitates ordering, billing, packaging, delivery, compensation and information exchange for items that are not normally stocked at stores having this type of constraint. An order station is located at the store; a central computer is located in the proximity to a warehouse containing the items ordered; off the shelf software, proprietary software and two-way communication means connecting the order station with the central computer facilitate transactions.

### FIELD OF THE INVENTION

The present invention generally relates to the field of an inventory and sales control system. In particular, the present invention relates to a system and method for reducing the need for a relatively small retail establishment to stock inventory of large items, items with low sales activity, seasonal items or special order items.

### BACKGROUND OF THE INVENTION

While there have been numerous sales and inventory control systems that have been developed which utilize computers and networks as an integral part of their operation, there continues to be a need for a comprehensive system that is particularly adapted for use in the sales and inventory of items for the owners of retail establishments with a relatively small square footage of floor space footprint. Within this segment of the marketplace the owners are reluctant to carry certain items in-house, e.g. items that take up considerable shelf space, items that come in many colors or with numerous options, seasonal items, items that sell infrequently.

A system that can allow a small footprint business to have customer friendly access to remote inventory without having to have physical inventory can be used in many different industries and businesses, but is particularly useful in the pool supply business. Many of the popular pool toys are quite bulky, take up considerable space, are seasonal and/or come in many colors or options.

Another problem in the industry is that many pool supply store owners do not have the ability to purchase pool toys because of cash flow limitations. Purchase of pool toys by retailers from wholesalers generally require bulk orders of multiple cases of a particular product.

Additionally, a pool supply store owner may misjudge a pool toy's popularity and will watch the cases of pool toys gather dust while taking up valuable space. In frustration, the pool supply store owner may have to significantly discount the pool toys.

Previous attempts to address the problem of inventory management include the following.

U.S. Pat. No. 4,884,208, issued to Bruce H. Schneider, et al., on Dec. 12, 1989, discloses a comprehensive inventory and sales control system that is particularly adapted for the segment of the furniture industry that involves special order items, such as sofas, love seats, upholstered chairs and the like. The system is adapted to provide instant communications between retail establishments and a manufacturer, and enables the order to be confirmed at the time of purchase. This includes a determination of the availability of the fabric and reserving the item style and fabric from the manufacturer's stock, thereby enabling the manufacturer to determine and the customer to know the anticipated delivery date for the item that has been purchased. The system also enables a point of sale establishment to maintain a set of fabric swatches or samples of the fabrics that are currently available, thereby minimizing the possibility that a customer would order an item and a fabric that is not currently available. Additionally, the system also has the capability of updating the inventory of available fabrics and a plurality of fabric swatches at each establishment, and a means for scanning bar coded labels that are attached to the swatches, wherein the scanning means has sound producing means that permits quick and easy control of the inventory of swatches.

U.S. Pat. No. 4,972,318, issued to Gordon T. Brown, on Nov. 20, 1990, discloses a method of order entry, product selection and inventory control for building products, building product accessories and building product components sold by a dealer to a customer. The method comprises the steps of providing a computer having a display screen and a plurality of files. A first file lists descriptions, dimensions and styles of available building products by product code along with building product accessories. A second file lists rough opening dimensions and building products fitting the rough opening dimensions and a third file lists building product components. A customer can enter into the computer a product code, a rough opening dimension or plural product codes for a desired building product. Based on the entry, the computer will select a building product. The computer then determines and displays the desired building product along with a price. The customer can then order the desired building product from an inventory.

U.S. Pat. No. 5,710,887, issued to Raman Chelliah, et al., on Jan. 20, 1998, discloses a system for facilitating commercial transactions between a plurality of customers and at least one supplier of items over a computer driven network capable of providing communications between the supplier and at least one customer site associated with each customer. Each site includes an associated display and an input device through which the customer can input information into the system. At least one supplier is presented on the display for selection by the customer using the input device. Similarly items from a supplier can be displayed for the customer to observe. Associated with a supplier of such items is an item database including information on presented items. Pricing subsystem receives information from the item database to determine the cost associated with a presented item. In addition a customer information database stores information relating to the customer. Associated with each customer is a customer monitoring object for each customer. The customer monitoring object is created by referencing information, relating to that customer, which had been stored in the customer information database and when the customer selects a supplier. The customer monitoring object is configured to operate by responding to customer enquiries regarding a presented item by retrieving information relating to the item and presenting the information to the customer; receiving a customer's selection of a presented item; receiving customer communications, indicating a desire to receive the item; and passing a communication to initiate the delivery of the item to the customer.

U.S. Pat. No. 5,712,989, issued to James M. Johnson et al., on Jan. 27, 1998, discloses a requisition and inventory management system which employs both a host computer and a local computer which can be linked to permit two-way data communications in a real time environment. Each computer has an associated database which can be accessed by that computer. By accessing its respective database, each computer can build and transmit to the other computer communications blocks of data relating to a particular requisition of an item in Just-in-Time (JIT) inventory or to the management of the JIT inventory. The other computer can then use the received data to continue processing of the requisition or to update its JIT inventory records. Thus requisition records are created from a real-time interaction between the host and local computers, with each computer using data from its respective database in conjunction with information entered by a Customer Service Representative (CSR) operating the local computer. The system of the present invention also utilizes means for automatically determining which items in the JIT inventory are likely to require replenishment. The system then proposes a purchase or transfer order for an optimum quantity of the item, which the CSR may accept or modify.

U.S. Pat. No. 6,341,269 B1, issued to Ear F. Dulaney, et al., on Jan. 22, 2002, discloses inventory management systems and processes at the retail, wholesale and/or distributor level. It particularly involves a system, method and article of manufacture that optimizes inventory and merchandising shelf space utilization based upon cost and lost sales, with or without considering physical space constraints. In one embodiment, the system includes a bank of memory, a processor, an input and an output, and a computer program. The system optimizes inventory or store facings using various data and extrapolated computations. The system optimizes inventory using facing optimization which is an approach to shelf inventory management that minimizes the sum of expected annual cost of lost sales and expected annual inventory holding cost. The process of facing optimization requires the assimilation of relevant data for each particular item to be evaluated. The data to be collected include store-level point-of-sale (a.k.a., POS) data, frequency of shelf replenishment, shelf-level order cycle time, space available, space required per SKU, number of units per facing, cost to the retailer of one unit of SKU, price they sell it for, the inventory holding cost factor, and the unit cost of a lost sale. Store-level POS is used to measure the mean of daily sales and the variability of daily sales (a.k.a., standard deviation of demand). The system evaluates these variables when determining the optimal solution for an unconstrained space or a constrained space of a particular facility.

U.S. Pat. No. 6,587,827 B1, issued to Carole Hennig et al., on Jul. 1, 2003, discloses a method and system for processing a customer generated order for a product, more particularly to a method for one or more client computers connected through a server to a plurality of supplier computers to fulfill a customer generated order. The method includes the client creating an order event with a preferred supplier, the server routing the order event to the preferred supplier, the server monitoring status of the order event from the preferred supplier, the preferred supplier processing the order event, and the server periodically synchronizing inventory between the client and all suppliers.

U.S. Pat. No. 6,681,989 B2, issued to William Kress Bodin on Jan. 27, 2004, discloses a system and method allowing a consumer to make a purchase within a retail area and to remove that purchased item from the retail area without causing an alarm by an electronic article surveillance (EAS) system. The system first identifies the consumer and the product to be purchased, then validates the selected item. If the selected product is a valid selection, then the system posts the transaction to the consumer's account, optionally including a convenience charge, and commands the EAS to allow removal of the purchased item from the secured retail area, thereby allowing the consumer to make the purchase and avoid waiting for the availability of a human cashier or salesperson.

U.S. Pat. No. 6,922,674 B1, issued to Timothy Edward Nelson, on Jul. 26, 2005, discloses a computer implemented purchasing system with aftermarket product inventory display. A list of aftermarket accessories for a selected vehicle model is displayed for incorporation into a purchase request generated by a potential buyer of the selected vehicle model. The list may be customized by the seller of the selected vehicle model.

While these patents and other previous methods have attempted to solve the problems that they addressed, none have utilized or disclosed a system and method for augmenting sales at small footprint retail establishment through customer friendly access to pool toy inventory as does embodiments of the present invention.

Therefore, a need exists for a system and method for augmenting sales at small footprint retail establishments with these attributes and functionalities. The system and method for augmenting sales in small footprint retail establishments according to embodiments of the invention substantially departs from the conventional concepts and designs of the prior art. It can be appreciated that there exists a continuing need for a new and improved system and method which can be used commercially for augmenting sales in small footprint retail establishments. In this regard, the present invention substantially fulfills these objectives.

The foregoing patent and other information reflect the state of the art of which the inventors are aware and are tendered with a view toward discharging the inventors' acknowledged duty of candor in disclosing information that may be pertinent to the patentability of the present invention. It is respectfully stipulated, however, that the foregoing patent and other information do not teach or render obvious, singly or when considered in combination, the inventors' claimed invention.

### BRIEF SUMMARY OF THE INVENTION

The general purpose of the present invention, which will be described subsequently in greater detail, is to provide a system and method for augmenting sales in small footprint retail establishment. In particular, the present invention relates to a computerized system and method for augmenting sales in small footprint retail establishments that sell water related supplies, e.g. pool supply stores, marina dock stores, RV-parks adjacent to pools or bodies of water.

The present invention is comprised of an order station located at the small footprint retail establishment, a central computer located at a large footprint warehouse establishment and two-way communication means connecting the order station with the central computer.

The order station is designed to require a minimum amount of floor space, with the width being 22 inches. In an exemplary embodiment the order station is comprised of a stand and a computer positioned underneath the stand. A keyboard, a monitor, a mouse, a phone line cord, a power cord and a financial card reader, are connected to the computer. The keyboard, monitor and mouse are positioned on the top surface of the stand. The credit card reader is positioned to be conveniently accessed by a user, e.g. on the side of the monitor.

An extension cord of sufficient length, e.g. up to 200 ft., with multiple electrical outlet connections is connected the power cord. In some embodiments a power backup device and/or surge protection device may be connected between the order station electrical devices and the power cord. The phone line cord is connected to a phone line jack in the retail establishment for communication with a central computer, e.g. at a pool supply warehouse. The computer has an operating system software installed, e.g. WINDOWS® XP, as well as a proprietary software for operation of the order station and communication with a central computer. In the preferred embodiment the order station is not operable for connection to the Internet. The stand is further comprised of signage designed to attract potential users, e.g. having an attractive water theme motif.

The present invention is further comprised of a central computer operable for communicating with a plurality of order station computers, via a telephone communications network, e.g. to upload orders and billing information from an order station computer, update the product data base of an order station computer, update the proprietary software an order station computer.

The central computer is operable for receiving and processing orders and billing data sent from each order station computer, transmitting this information to the warehouse for pulling, packaging and shipping, sending an email with the shipping tracking information to the email for the respective establishment, calculating commissions, aggregating those commissions and creating a commission payment. The central computer is also operable for updating each order station computer with revised product information and/or software changes.

One aspect of the present invention is that it provides an inventory solution to small footprint retail establishments by allowing the ordering of an individual item that is shipped via an express delivery service to the retail establishment.

Another aspect of the present invention is that it is easy to install.

Another aspect of the present invention is that it is easy to use.

Another aspect of the present invention is that it provides an additional source of profit to small footprint retail establishments.

Another aspect of the present invention is that items returned to a small footprint retail establishment are considered a gift to the establishment owner and can be resold with the establishment owner keeping the entire sales price as profit.

Another aspect of the present invention is that communication between the order station and the central computer occurs after normal store hours, e.g. 3 am.

Another aspect of the present invention is that an email from the central computer is sent to the retail establishment's email address containing the details of the transaction and the shipping tracking number.

Another aspect of the present invention is that ordered items are sent via overnight delivery to the ordering store so the customer returns to the store for pickup and potentially becomes a repeat customer.

Another aspect of the present invention is that a data base of the customers who have used the order station is available to the corresponding retail establishment to facilitate follow-up sales.

Another aspect of the present invention is that commissions for the retail establishment are aggregated and paid periodically, e.g. monthly.

Another aspect of the present invention is that it can be made inexpensively.

Another aspect of the present invention is that it can be made of readily available materials.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a perspective view of an ordering station according to one embodiment of the present invention.

FIG. 2 illustrates an entry screen of an ordering station according to one embodiment of the present invention.

FIG. 3 illustrates a general ordering screen of an ordering station according to one embodiment of the present invention.

FIG. 4 illustrates a category order screen of an ordering station according to one embodiment of the present invention.

FIG. 5 illustrates an item ordering screen of an ordering station according to one embodiment of the present invention.

FIG. 6 illustrates a shipping information screen of an ordering station according to one embodiment of the present invention.

FIG. 7 illustrates a payment method selection screen of an ordering station according to one embodiment of the present invention.

FIG. 8 illustrates a billing information screen of an ordering station according to one embodiment of the present invention.

FIG. 9 illustrates a series of steps to process an order at an ordering station according to one embodiment of the present invention.

FIG. 10 illustrates a series of steps to process and ship at least one order according to one embodiment of the present invention.

FIG. 11 illustrates a series of steps to process commissions according to one embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

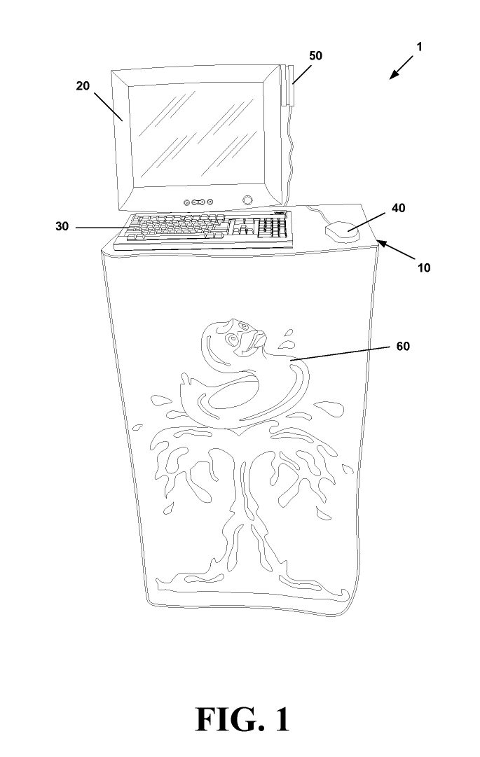

FIG. 1 illustrates a perspective view of an ordering station 1, according to one embodiment of the present invention. Ordering station 1 is comprise of a stand 10, an order station computer (not shown), a monitor 20, a keyboard 30, a mouse 40 and a financial card reader 50 all connected the order station computer. Connected to the order station computer are a power cord (not shown) and a phone line connector (not shown). The order station computer has an operating system and proprietary software loading therein. Ordering station 1 is further comprised of a signage 60.

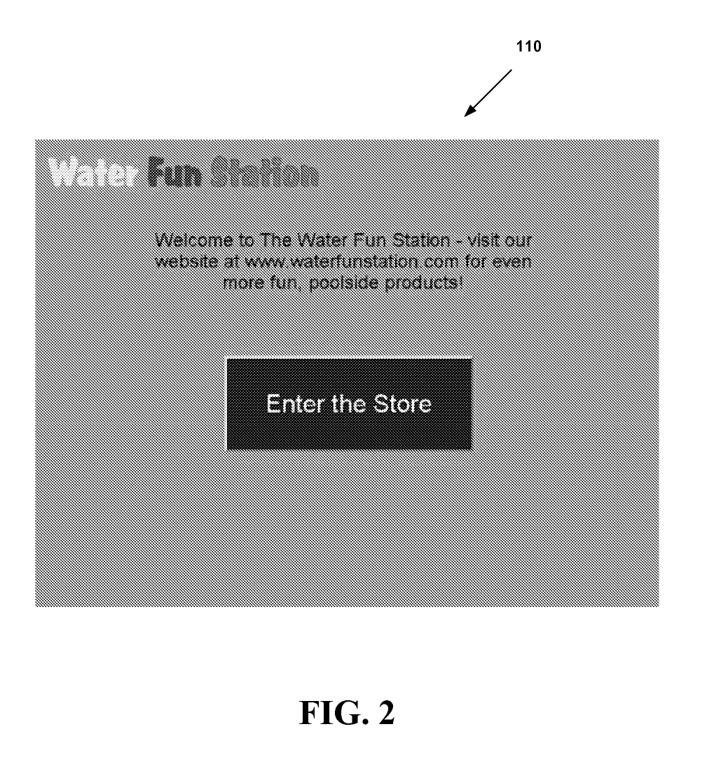

FIG. 2 illustrates an entry screen 110 for an ordering station, according to one embodiment of the present invention.

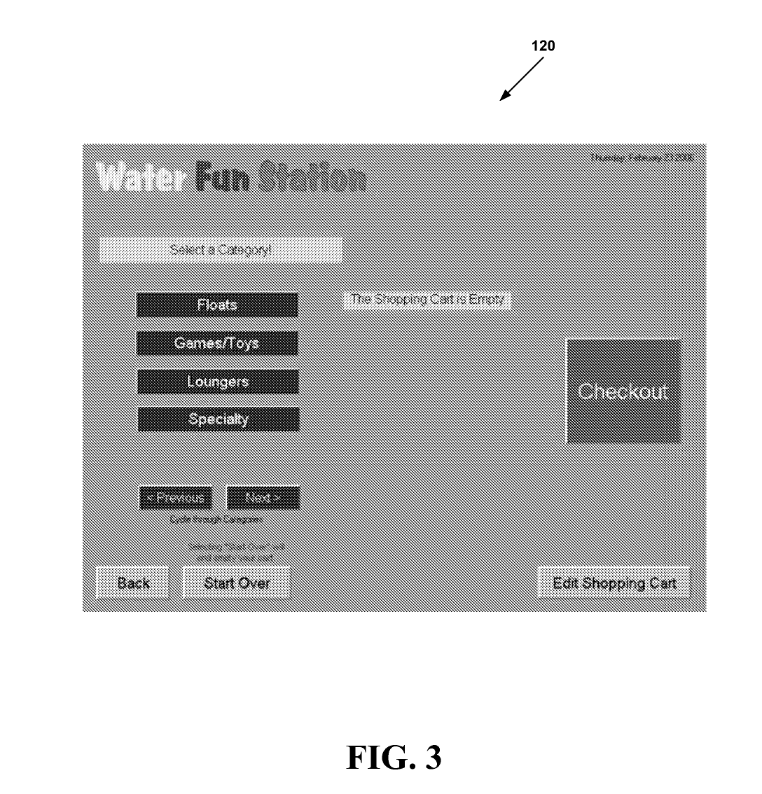

FIG. 3 illustrates a general order screen 120 for an ordering station, according to one embodiment of the present invention.

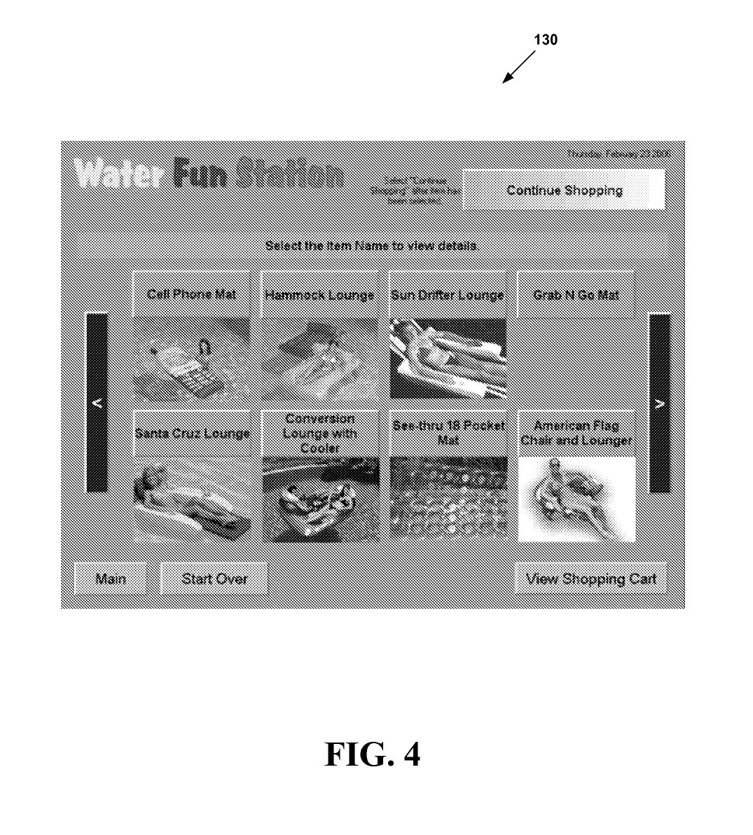

FIG. 4 illustrates a category order screen 130 for an ordering station, according to one embodiment of the present invention.

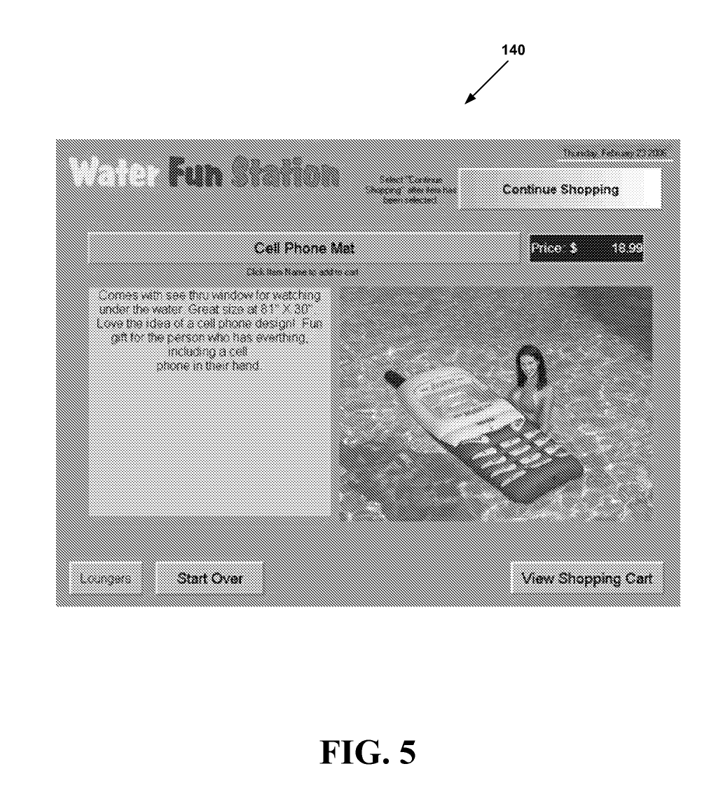

FIG. 5 illustrates an item order screen 140 for an ordering station, according to one embodiment of the present invention.

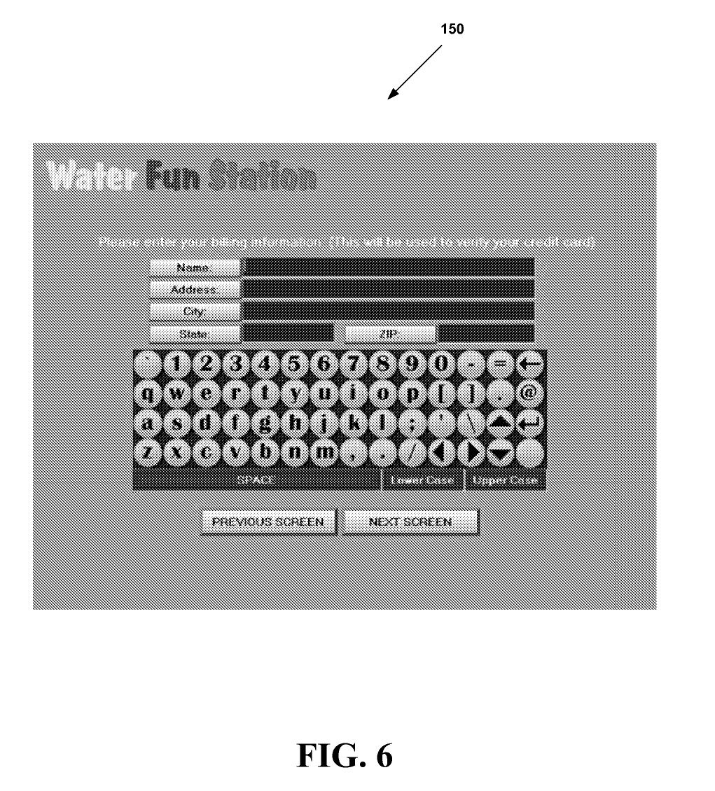

FIG. 6 illustrates a shipping screen 150 for an ordering station, according to one embodiment of the present invention.

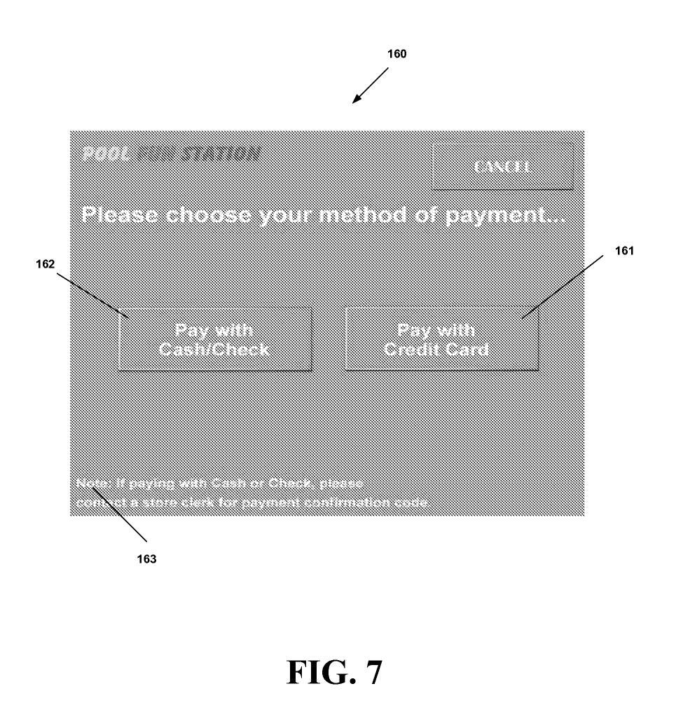

FIG. 7 illustrates a payment method selection screen 160 for an ordering station, according to one embodiment of the present invention. A credit card payment button 161 is illustrated, as is a cash/check payment button 162. When a customer selects cash/check payment button 162, he/she is prompted by a note 163 to have a store clerk come to order station 1 to enter a payment confirmation code to indicate that the store owner has received full payment for the order.

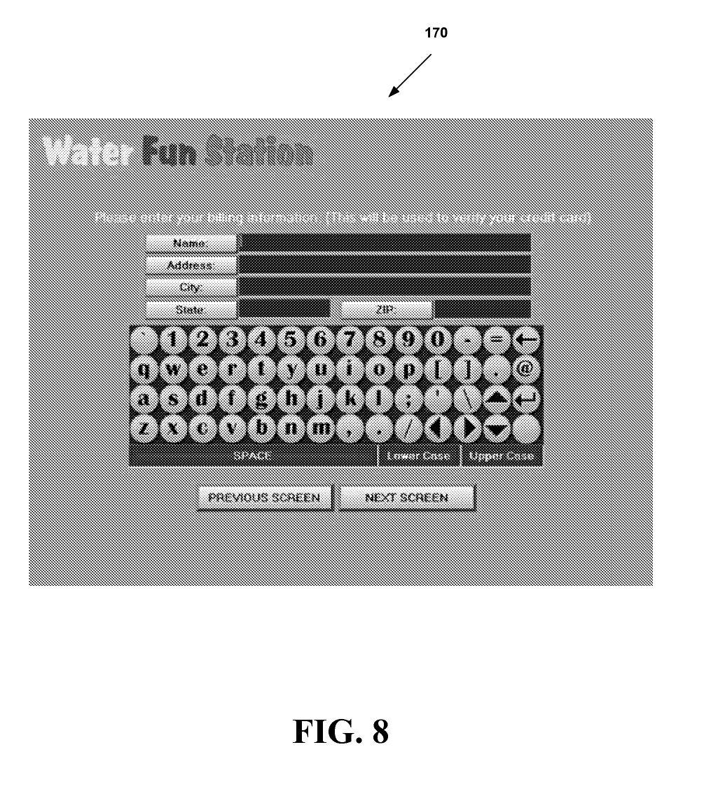

FIG. 8 illustrates a credit card billing information screen 170 for an ordering station, according to one embodiment of the present invention.

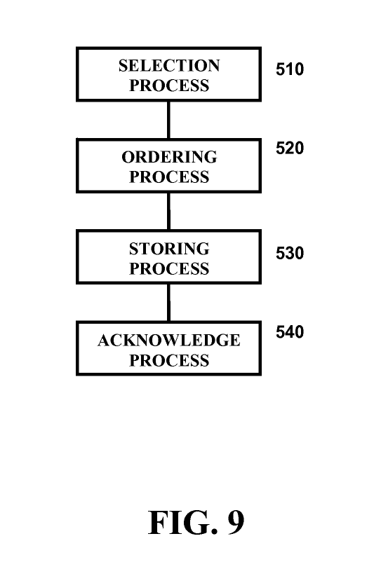

FIG. 9 illustrates a series of steps taking a customer through the in-store ordering process, according to one embodiment of the present invention. In step 510 a customer enters via an entry screen and navigates through a series of screens to select one or more items to order. In step 520, the customer completes the order and makes a payment arrangement, either by credit card or by paying with cash, check or debit card to a store clerk. In step 530 the completed order and related data is stored within the order station computer. In step 540 an acknowledgement screen, e.g. “Thanks for your order,” is displayed to the customer.

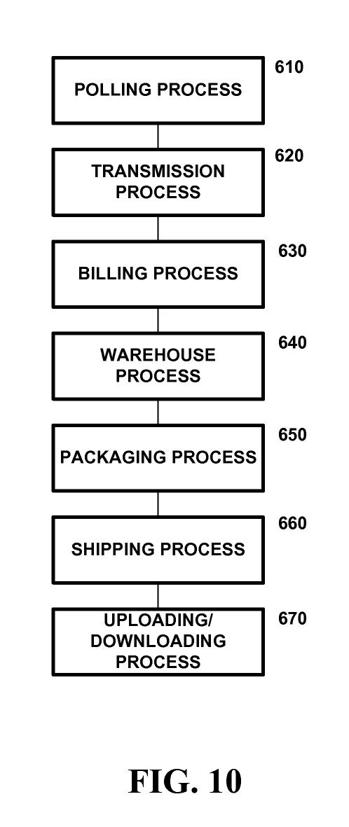

FIG. 10 illustrates a series of steps for processing stored order information, according to one embodiment of the present invention. In step 610, an ordering station computer dials, and connects to, the central computer via a telephone communications network at a preset time for that particular ordering station, preferably after normal store hours, e.g. 3:00 am. In step 620 identification data and stored order data are transmitted to the central computer. In step 630 the central computer validates the credit card information and updates the account associated with that particular order station. In step 640, the item and shipping information is transmitted to the warehouse and the items are pulled from inventory. In step 650 the pulled items are packaged and shipping labels are attached to the packaging. In step 660 one or more shipping tracking codes are obtained, associated with the corresponding orders, the packages are shipped, preferably via overnight shipping and the tracking code information is sent to the email address and/or fax associated with the corresponding order station. In step 670 uploading and/or downloading occurs between the central computer and an ordering station computer, e.g. to delete items no longer available, add new items, change prices, modify the proprietary software.

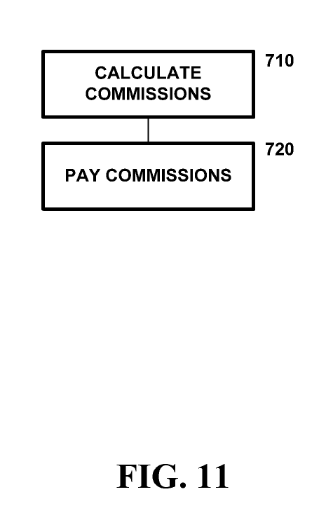

FIG. 11 illustrates a series of steps for processing the financial status of accounts associated with an order station, according to one embodiment of the present invention. In step 710 commissions are calculated using the order information and the commission rates associated with the items order and/or the order station. Items that were paid for by cash, check or debit card are subtracted from the commission total. In step 720 commissions are paid based on the commission payment information associated with the order station. In those cases where the cash, check and debit card total is greater than the commission total an invoice may be generated and sent to the address associated with the order station. Optionally, the negative balance may be carried over to the next commission payment period, depending on a rule set governing this condition.

The individual steps illustrated may be executed in a different sequence, be omitted or modified, and additional steps may be added at the beginning, the end or between the steps illustrated, in different embodiments of the present invention.

What is claimed is:

1. A system for augmenting sales in small footprint retail sales establishments comprising:
a central computing means for processing information indicative of a plurality of available items at a central inventory location;
at least one remote computing means, preferably located at a point of sale location, each such remote computing means being adapted to attract a customer and to facilitate the creation of a paid order for at least one purchased item;
means for communicating information between the central computing means and each of the remote computing means;
means for selecting the at least one purchased item from the plurality of available items in the central inventory;
means for packaging the at least one purchased item;
means for associating a shipping tracking number with the at least one purchased item;
means for shipping the at least one purchase item; and
means for communicating the shipping tracking number to the point of sale location associated with the remote computing means.

2. The system as recited in claim 1, further comprising:
means for periodically computing a commission associated with each remote computing means; and
means for delivering a commission payment to each point of sale location associated each remote computing means.

3. The system as recited in claim 2, further comprising means for periodically updating the information in each remote computing means.

4. An order station suitable for augmenting sales at a small footprint retail sales establishment comprising:
a stand having a top surface supported by a plurality of legs extending downward from the top surface to a floor, wherein the stand is operable for supporting a weight of at least five pounds;
a computer having an operating system, an ordering system, a communications system and an update system, preferably placed on the floor underneath the stand;
a keyboard placed on the top surface of the stand and operably connected to the computer;
a monitor placed on the top surface of the stand and adjacent to the keyboard and operably connected to the computer;
a computer mouse placed on the top surface of the stand and adjacent to the keyboard and operably connected to the computer;
a financial card reader operably connected to the computer;
a phone line operably connecting the computer to an access point for a telephone communications network;
a power cord operably connecting the computer and the monitor to an electrical outlet; and
a display attached to the stand, wherein the display has a theme designed to attract a customer to the order station.

5. The order station as recited in claim 4, wherein the ordering system is operable for the customer to pay by check by prompting the customer to have a store clerk enter a pass code.

6. The order station as recited in claim 4, wherein the ordering system is operable for the customer to pay by cash by prompting the customer to have a store clerk enter a pass code.

7. The order station as recited in claim 4, wherein the ordering system is operable for the customer to pay by debit card by prompting the customer to have a store clerk enter a pass code.
